(19) United States
(12) Patent Application Publication
(10) Pub. No.: US 2005/0015579 A1
(43) Pub. Date: Jan. 20, 2005

(54) Handling exceptions

(76) Inventors: Rajeev Grover, Rocklin, CA (US); Kenneth C. Duisenberg, Roseville, CA (US); John Nolan, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/621,207

(22) Filed: Jul. 15, 2003

(51) Int. Cl. G06F 9/00

(52) U.S. Cl. 712/244

(57) ABSTRACT

Techniques for handling exceptions are disclosed. In an embodiment, an exception-handling scheme supports an embedded system. An exception handler records information related to the exception. An intelligent recovery agent determines if the erroneous process should be terminated, recovered, etc. The recovery agent also determines the most efficient recovery method, etc. A post-exception analysis tool identifies the cause of the exception.

### FIELD OF THE INVENTION

The present invention relates generally to program exceptions and, more specifically, to handling such exceptions.

### BACKGROUND OF THE INVENTION

Exceptions commonly refer to a condition that indicates unexpected errors while a program is executing. Normally, the program catches and handles exceptions within the program thread's of execution while the operating system handles exceptions that are not caught by the program. Without a good exception handler, the program and/or the system running the program may require a hard reboot, abortion of the program and/or the system, etc. Large-scale computer systems usually include exception handlers, which, however, require sophisticated structures, large amount of memory and disk space, etc. Many exception handlers do not record enough information, do not provide recovery mechanisms, do not support exception analysis, etc. Because the operating system in large-scale computers system is typically designed for a particular platform that handles various processes, the operating system has higher priority than those processes. Consequently, an exception handler provided with the operating system is usually designed to stabilize the operating system, rather than the processes, and, in many cases, the exception handler simply terminates the erroneous process to stabilize the operating system. The exception handler then leaves it up to the user to whether restart the process or not. Many embedded systems do not even support exception handlers.

Based on the foregoing, it is desirable that mechanisms be provided to solve the above deficiencies and related problems.

### SUMMARY OF THE INVENTION

The present invention is related to handling exceptions. In an embodiment, an exception-handling scheme includes an exception handler, an intelligent recovery agent, and a post-exception analysis tool all of which support an embedded system. The exception handler records information related to the exception. The recovery agent determines appropriate courses of actions such as whether to terminate, to recover a process, etc. The recovery agent also determines the most efficient method for recovery, including restarting the process as appropriate. The post-exception analysis tool identifies the cause of the exception.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows a computing system upon which embodiments of the invention may be implemented;

FIG. 2 shows tools related to handling exceptions for the service processor in FIG. 1;

FIG. 3 shows a table used by the exception handling mechanism; and

FIG. 4 shows a computer system upon which embodiments of the invention may be implemented.

### DETAILED DESCRIPTION OF THE PREFERRED EMBODIMENT

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### OVERVIEW

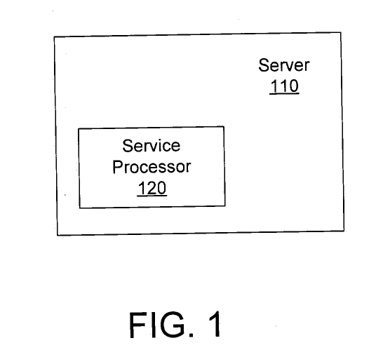

FIG. 1 shows a computing system 110 embodied as a server upon which embodiments of the invention may be implemented. Server 110 includes service processor 120 on a card being part of server 110. Identifiers of server 110 such as a Media Access Control (MAC) address, an Asynchronous Transfer Mode (ATM) address, etc., may be used to identify service processor 120. Through appropriate hardware and/or software, server 110 communicates with service processor 120 via a bus, a point-to-point interconnect, an input/output (I/O) interconnect, other interconnect mechanisms, etc., including, for example, a Peripheral Component Interconnect (PCI) bus, an Industry Standard Architecture (ISA) bus, an Extended Industry Standard Architecture (EISA) bus, a Personal Computer Memory Card International Association (PCMCIA) card, an infini band, their equivalence, etc. Embodiments of the invention are not limited to how service processor 120 is embedded in server 110.

Service processor 120 includes hardware and software to provide administrative capabilities to server 110, such as providing event monitor and notification, power management, access to console of server 110, etc. Service processor 120 also acts as a console and front panel display redirector, allowing a user via a console client to have the same set of functionalities and level of controls of server 110. Service processor 120 allows interactions between a console client and program applications on server 110. This console client may be connected to server 110 locally, e.g., through an asynchronous link, or remotely, e.g., through a network. Those skilled in the art will recognize that a console is means from which a user gets access to some functions of a computer system, including, for example, checking status of the system, performing system administration, updating system software, configuring system hardware, etc. Normally, a console, being used interchangeably with a terminal, includes a monitor and a keyboard or input device. Service processor 120 also provides system support and management functions for server 110, including providing remote access over a network for managing server 110's boot and reset, providing remote maintenance such as power management, event logs, event filtering and notifications, etc. Service processor 120 is integrated as an input/output (I/O) device to server 110, and acts as an autonomous embedded device, which is powered independently and runs embedded applications independent of server 110's state. Server 110 may properly function with or without service processor 120 or with service processor 120 being inoperative. Further, service processor 120 is commercially available without a terminal, and is referred to as an embedded management processor or device because service processor 120 is part of server 110 and provides management services for server 110.

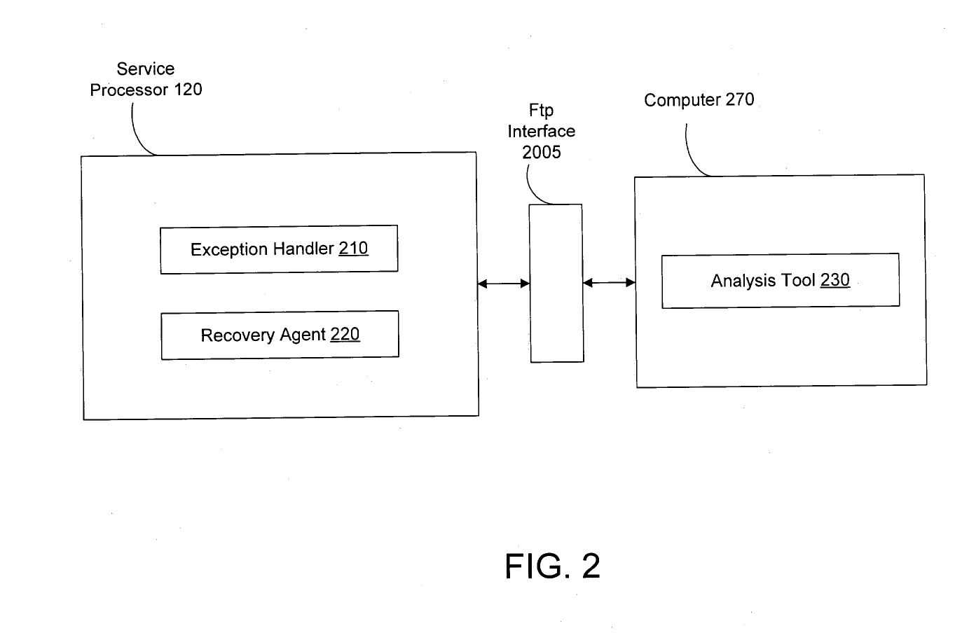

FIG. 2 shows tools related to handling exceptions for service processor 120, in accordance with an embodiment that includes an exception handler 210, an intelligent recovery agent 220, and a post-exception analysis tool 230. Exception handler 210 and recovery agent 220 run on service processor 120 while analysis tool 230 runs on a computer 270, which is external to service processor 120. However, if memory space permits, analysis tool 230 may also run on service processor 120. Exception handler 10, recovery agent 220, and the operating system of service processor 120 are part of the environment or part of a program running on service processor 120. Alternatively, the operating system and its applications are lumped into one “system,” in which each application is a thread performing specific actions. In service processor 120, each thread running on the system and dependencies between the threads can be identified.

Generally, a programmer, through the program, provides information to the operating system so that when an exception occurs, the operating system, via recovery agent 220 and the provided information, can take appropriate actions. For example, if the operating system is to re-start a process, the operating system is provided with parameters required to re-start the process and dependencies of the process, etc. If the operating system is to terminate a process, the operating system knows what kind of cleanup must be performed, etc.

Exception handler 210 records information related to an exception when it receives a signal from the hardware indicating that the exception has occurred. Generally, exception handler 210 records the information dependant on the type of exception and the task or process that causes the exception. Examples of exception types include unaligned access, divided by zero, undefined and thus invalid instructions, software interrupts, pre-fetch abort, data abort, etc. Examples of tasks include command handler, LAN monitor, console routing, etc. Based on the recorded information, the exception may later be debugged. Further, exception handler 210 records the information onto non-volatile random access memory (NVRAM), which is part of service processor 120. Normally, NVRAM retains its content even if the power is turned off, and includes, for example, electrical programmable read-only memory (EPROM), erasable EPROM (EEPROM), battery-backed memory, their equivalences, etc. In an embodiment, data in NVRAM is compressed to reduce storage space using one and/or a combination of compression algorithms such as the Lempel-Zif-Welch (LZW), the run-length encoding (RLE), the Huffman techniques, etc.

Exception information is commonly referred to as “error data dump,” which, in an embodiment, is associated with a signature to identify the data. The signature may also include a version number of the program. This version number is thus the same for the source code and the object code. Because each data dump is associated with a distinct signature, various sets of data dump may be kept in NVRAM of processor 120. Based on these data sets, a history of exceptions may be reviewed and analyzed.

The signature also helps determine whether the data is a valid data dump, e.g., versus random data. Various techniques such as digital signatures, checksums or flags may be used to verify whether the data is valid. The signature also indicates the format of the data dump based on which the information is later decoded. For example, in an embodiment, information in a data dump is stored in the order of the signature, the timestamp, the register information, the type and location of exception, the stack information, the error log entries, the data flags. Once a data structure is defined for a data dump, a format number is assigned to that data dump, and, when the structure is modified, another format number is assigned to the revised data dump structure. In an embodiment, a signature is a bit pattern having four bytes that include the program version number in two bytes.

Examples of data in an error dump include signatures, date and time of an exception, locations and types of the exception, names and starting functions for a task that is directly involved in an error dump, stack space for the exception and the application in which the exception occurs, the amount of used stack space and the allocated space, the stack for each task in the application, the number of entries last recorded in the error log, a flag indicating a valid dump, a flag indicating whether the data dump has been read and/or saved, contents of various registers, values of variables (heap, global, etc.), results of diagnostic tests, etc. For example, the dump signature is “MPD2,” exception type is “unaligned access,” task name is “command task,” exception location is “0x3200,” the allocated stack space is “100 bytes,” etc. Different types of information/data may be recorded for different types of processes and/or types of exceptions.

Recovery agent 220 detects an exception and takes appropriate actions. In general, recovery agent 220 identifies the task that causes the exception and the type of exception, both of which may be provided by the operating system, and, based on which, recovery agent 220 takes actions, including retrieving additional information for a particular task and/or type of exception. Courses of actions include, for example, restarting a task, resetting hardware device, re-initializing drivers, restarting several tasks, cleaning-up data and continue, resetting service processor 120, alerting users through the interface of service processor 120, notifying the system administrator, logging errors in NVRAM, sending event information to other monitoring tools such as toptools, patching problems in firmware by upgrading images in ROM, disregarding the error, etc. Different tasks and/or types of exception call for different courses of actions. For example, a user-interface task can be restarted immediately because the task does not process much information except for capturing inputs from users. A telnet session may require data cleanup before being restarted because it may store some data in memory that will become stale if not cleaned up, etc.

In an embodiment, recovery agent 220 uses information in a table to take actions. The operating system provides the context in which recovery agent 220 runs while recovery agent 220 uses the provided information in the table to come up with specific actions to take. In effect, the table is a way of selecting an action for a corresponding exception scenario. Before an application is running, information in the table is fed to the operating system of service processor 120 so that, when appropriate, the operating system acts accordingly. For example, the operating system may use the information in the table to restart, abandon, etc., a process. Information in the table includes parameters to be passed to a process, dependency of a process, etc.

Recovery agent 220 also collects additional information as appropriate. For example, if a console routing exception occurs, then recovery agent 220 collects additional information related to the PCI register, checks the status of the outbound path including the LAN modem, the serial port, determines whether the data buffer is full, the hardware is running properly, etc. For another example, if an HTTP daemon occurs, then recovery agent 220 determines whether the stack pointer runs over the top of the stack, collects information about the stack pointer, the register information, memory information such as the amount of memory that is available and/or being used, etc.

Analysis tool 230 analyzes the data, identifies causes of the exception, the location in both the source and object code that causes the exception, etc. Generally, tool 230 runs on computer 270 and is connected via a network such as a LAN, an intranet, etc., to service processor 120 so that the dump data may be transferred between service processor 120 and computer 270 for analyzing the exception data. In an embodiment, tool 230 uses an ftp interface 2005 that allows communication between service processor 120 as an ftp client and computer 270 as an ftp server. Tool 230, from the dumped data, extracts the version of service processor 120, and uses this version to reference the correct version of the source code. Tool 230 uses the exception location data from the dump data to locate the source code line that caused the exception. Tool 230 can also show the content of registers used in the application, information related to the stack, etc. Based on the dumped data, tool 230 unfolds the program stack, identifies the call chain, which indicates, for example, that task A is in function B, which is called by function C, which in turn is called by function D, etc. Tool 230 also provides the information usually in the form of parameter list passed from on function to another function.

### THE TABLE

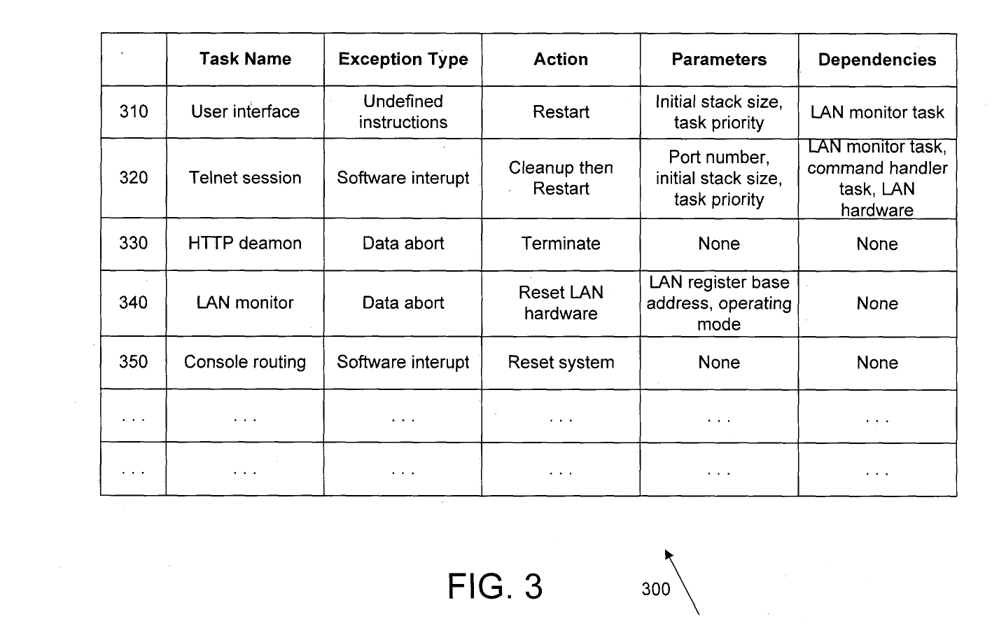

For illustration purposes, FIG. 3 shows a few rows of an exemplary table 300 for use by the exception handling mechanism, in accordance with an embodiment. In row 310, a user interface task encounters an exception. The exception type is “undefined instruction,” and recovery agent 220 restarts this user interface task. However, recovery agent 220 seeks parameters such as initial stack size and task priority. The user interface task depends on the LAN monitor task.

In row 320, in response to a telnet session encountering a software interrupt exception, recovery agent 220 cleans up undesirable data produced by the exception, then restarts the session. Recovery agent 220 passes parameters such as the port number, the initial stack size, and the task priority. The telnet session depends on the LAN monitor task, the command handler task, and the LAN hardware.

In row 330, an HTTP daemon encounters an exception, which is classified as “data abort.” Recovery agent 220 does not pass any parameter and simply terminates the task because there is no dependency.

In row 340, a LAN monitor task encounters a data-abort exception after which recovery agent 220 resets the LAN hardware. Recovery agent 220 passes parameters such as the LAN register, the base address, and the operating mode.

In row 350, a console routing task encounters a software interrupt exception, and, in response, recovery agent 220 resets service processor 120.

Embodiments of the invention are advantageous over other approaches because, when an exception occurs, rather than just stopping the erroneous process, various options may be made, including re-starting the process, transferring data for analysis, reconstructing the program stack, etc.

### COMPUTER SYSTEM OVERVIEW

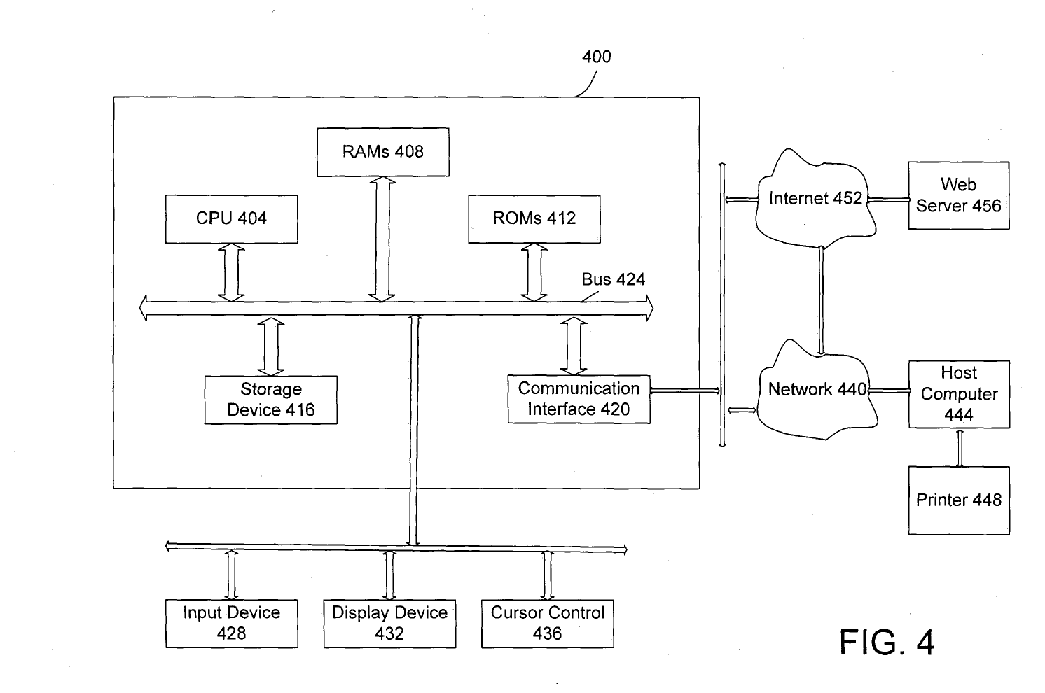

FIG. 4 is a block diagram showing a computer system 400 upon which an embodiment of the invention may be implemented. For example, computer system 400 may be implemented to operate as a server 110, as a computer 270, to perform functions in accordance with the techniques described above, etc. In one embodiment, computer system 400 includes a central processing unit (CPU) 404, random access memories (RAMs) 408, read-only memories (ROMs) 412, a storage device 416, and a communication interface 420, all of which are connected to a bus 424.

CPU 404 controls logic, processes information, and coordinates activities within computer system 400. In one embodiment, CPU 404 executes instructions stored in RAMs 408 and ROMs 412, by, for example, coordinating the movement of data from input device 428 to display device 432. CPU 404 may include one or a plurality of processors.

RAMs 408, usually being referred to as main memory, temporarily store information and instructions to be executed by CPU 404. Information in RAMs 408 may be obtained from input device 428 or generated by CPU 404 as part of the algorithmic processes required by the instructions that are executed by CPU 404.

ROMs 412 store information and instructions that, once written in a ROM chip, are read-only and are not modified or removed. In one embodiment, ROMs 412 store commands for configurations and initial operations of computer system 400.

Storage device 416, such as floppy disks, disk drives, or tape drives, durably stores information for use by computer system 400.

Communication interface 420 enables computer system 400 to interface with other computers or devices. Communication interface 420 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 420 may also allow wireless communications.

Bus 424 can be any communication mechanism for communicating information for use by computer system 400. In the example of FIG. 4, bus 424 is a media for transferring data between CPU 404, RAMs 408, ROMs 412, storage device 416, communication interface 420, etc.

Computer system 400 is typically coupled to an input device 428, a display device 432, and a cursor control 436. Input device 428, such as a keyboard including alphanumeric and other keys, communicates information and commands to CPU 404. Display device 432, such as a cathode ray tube (CRT), displays information to users of computer system 400. Cursor control 436, such as a mouse, a trackball, or cursor direction keys, communicates direction information and commands to CPU 404 and controls cursor movement on display device 432.

Computer system 400 may communicate with other computers or devices through one or more networks. For example, computer system 400, using communication interface 420, communicates through a network 440 to another computer 444 connected to a printer 448, or through the world wide web 452 to a server 456. The world wide web 452 is commonly referred to as the “Internet.” Alternatively, computer system 400 may access the Internet 452 via network 440.

Computer system 400 may be used to implement the techniques described above. In various embodiments, CPU 404 performs the steps of the techniques by executing instructions brought to RAMs 408. In alternative embodiments, hard-wired circuitry may be used in place of or in combination with software instructions to implement the described techniques. Consequently, embodiments of the invention are not limited to any one or a combination of software, firmware, hardware, or circuitry.

Instructions executed by CPU 404 may be stored in and/or carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic or electromagnetic waves, capacitive or inductive coupling, etc. As an example, the instructions to be executed by CPU 404 are in the form of one or more software programs and are initially stored in a CD-ROM being interfaced with computer system 400 via bus 424. Computer system 400 loads these instructions in RAMs 408, executes some instructions, and sends some instructions via communication interface 420, a modem, and a telephone line to a network, e.g. network 440, the Internet 452, etc. A remote computer, receiving data through a network cable, executes the received instructions and sends the data to computer system 400 to be stored in storage device 416.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

1. An exception handling mechanism comprising:
an exception handler for recording exception information dependant on types of exceptions and programming tasks that encounter exceptions; and
a recovery agent for taking an action upon an occurrence of an exception;
wherein the action to be taken upon the occurrence of the exception corresponds to a type of exception and a programming task, and includes one or a combination of restarting the programming task, terminating the programming task, resetting a system running the programming task, and disregarding the exception.

2. The mechanism of claim 1 wherein the recorded exception information associated with an exception is associated with a signature for identifying the recorded exception information with its associated exception.

3. The mechanism of claim 2 wherein the signature includes a version of a program running the programming task.

4. The mechanism of claim 1 wherein a plurality of sets of exception information for a plurality of exceptions is maintained in the system running the programming task; each set of exception information being associated with a signature for identifying that set of exception information.

5. The mechanism of claim 1 wherein the recorded exception information associated with an exception is associated with a signature for identifying the format of the exception information.

6. The mechanism of claim 1 wherein the recorded exception information includes data related to the program stack, including data to reconstruct the stack at time of exception.

7. The mechanism of claim 1 further comprising an analysis tool communicating via an interface with the system running the programming task, for identifying causes of the exception.

8. The mechanism of claim 7 wherein the analysis tool uses a version to match the object code of a program running the programming task to the source code of the program.

9. The mechanism of claim 1 wherein the exception handler and the recovery agent run on a first system embedded in a second system.

10. A processing system comprising:
a first system;
a second system embedded in the first system;
an exception handler running in the second system for recording exception information upon an occurrence of an exception in the second system; and
a recovery agent running on the second system, for taking an action upon the occurrence of the exception based on the recorded exception information;
wherein the action corresponds to a type of exception and a programming task.

11. The processing system of claim 10 further comprising an analysis tool for receiving, via an interface, the recorded exception information from the second system and for identifying the cause of the exception.

12. The processing system of claim 10 wherein the second system includes non-volatile memory for storing exception information.

13. The processing system of claim 12 wherein the exception information stored in the non-volatile memory is compressed.

14. The processing system of claim 12 wherein the exception information stored in non-volatile memory includes a plurality of sets of exception information, each set being associated with an exception and a signature.

15. A computing system comprising:
an exception handler for recording exception information on non-volatile memory upon an occurrence of an exception;
a recovery agent for taking an action upon the occurrence of the exception based on the recorded exception information; and
an analysis tool for identifying the cause of the exception;
wherein the analysis tool receives the exception information from the non-volatile memory via an interface interfacing a first system and a second system running the exception handler and the recovery agent.

16. The computing system of claim 15 wherein the second system is embedded in a third system.

17. The computing system of claim 15 wherein the recorded exception information includes data related to a program stack.
